(19) United States
(12) Patent Application Publication
(10) Pub. No.: US 2012/0133227 A1
(43) Pub. Date: May 31, 2012

(54) MOTOR DRIVE SYSTEM ARRANGEMENT TO REDUCE TORQUE RIPPLE

(75) Inventor: Paul Boskovitch, Costa Mesa, CA (US)

(73) Assignee: Fisker Automotive, Inc.

(21) Appl. No.: 13/336,530

(22) Filed: Dec. 23, 2011

Related U.S. Application Data
(63) Continuation of application No. PCT/US2010/039836, filed on Jun. 24, 2010.
(60) Provisional application No. 61/220,081, filed on Jun. 24, 2009.

(51) Int. Cl. H02K 16/00

(52) U.S. Cl. 310/112

(57) ABSTRACT

A vehicle motor drive system having a first motor and a second motor connected by a common rotatable shaft, wherein the shaft is in operable engagement with a first and second wheel. The first motor is coupled to the first end of the rotatable shaft member and the second motor is coupled to the second end of the rotatable shaft member. The first motor and the second motor are mounted ninety electrical degrees out of phase from one another to minimize lorque ripple.

### CROSS REFERENCE TO RELATED APPLICATIONS

This application claims the benefit of and priority to U.S. Provisional Application No. 61/220,081, Jun. 24, 2009, which is incorporated herein by reference.

### BACKGROUND

The present disclosure relates generally to a hybrid vehicle motor drive system, and more particularly to a motor arrangement to reduce torque ripple in a motor drive system having multiple motors on a common shaft.

### DESCRIPTION OF THE RELATED ART

Hybrid electric vehicles (HEV) and full electric vehicles (FEV) use motors to convert electrical energy into kinetic energy. Whereas HEVs combine an internal combustion engine and one or more electric motors, FEVs use electrical motors exclusively. The motors are typically part of a motor drive system. The motor drive systems may include two or more motors connected on a common shaft. These motors typically have a known amount of torque ripple (unsmooth torque caused by the rotor as it moves from one position to another in variable speed motor drives), whereby the output torque fluctuates at a frequency and magnitude dependent on the motor design and the operating condition. Motor design and operating conditions that affect torque ripple include magnet design, number of slots, number of poles, air gap flux density harmonics, or the like. This torque ripple may be noticeable by the vehicle occupant(s) and is undesirable because it may reduce occupant comfort and enjoyment, and/or vehicle performance. Minimizing or eliminating the effect is preferred to enhance occupant comfort and improve vehicle performance. Conventional techniques for minimizing torque ripple include modifying the magnet design and or the winding layout of the motor drive system. These conventional techniques, however, can be costly, ineffective and/or inefficient.

Accordingly, there is a need in the art for a motor drive system that minimizes or eliminates torque ripple in a more cost effective and efficient manner.

### SUMMARY

Accordingly, the present disclosure relates to a vehicle motor drive system having a first motor and a second motor connected by a common shaft, wherein the shaft is in operable engagement with a first and second wheel. The first motor is coupled to the first end of the rotatable shaft member and the second motor is coupled to the second end of the rotatable shaft member. The first motor and the second motor are mounted ninety electrical degrees out of phase from one another to minimize torque ripple.

One advantage of the present disclosure is that the motor drive system has a motor arrangement that minimizes torque ripple more cost effectively and efficiently.

Other features and advantages of the present disclosure will he readily appreciated, as the same becomes better understood after reading the subsequent description taken in conjunction with the accompanying drawings.

### BRIEF DESCRIPTION OF THE DRAWINGS

FIG. 1 is a perspective view of a hybrid vehicle, according to an exemplary embodiment.

FIG. 2 is a top view of the vehicle of FIG. 1, according to an exemplary embodiment.

FIG. 3 is a schematic view of a motor drive system having two motors coupled to a common shaft, according to an exemplary embodiment.

FIG. 4 is a diagrammatic view of a first and second motor alignment during installation onto a common shaft, according to an exemplary embodiment.

FIG. 5 is a graph comparing torque ripple in two different motor arrangements.

FIG. 6 is a graph comparing relative torque versus the rotor angle between a first motor, a second motor, and combined first and second motor.

### DESCRIPTION

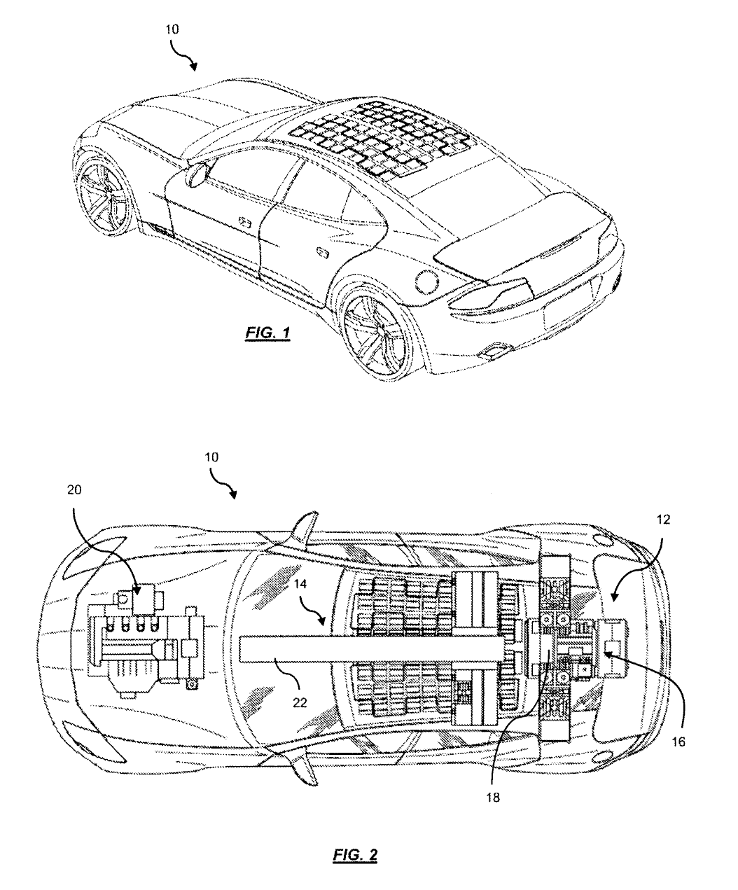

Referring generally to the Figures and particularly to FIGS. 1 and 2, a hybrid vehicle 10 is illustrated. In this example the vehicle 10 is a plug-in hybrid vehicle that is gasoline and electric powered. The vehicle 10 may be a passenger car, truck, or other type of vehicle having an motor drive system 12. The vehicle 10 also includes a power train 14 that controls the operation of the vehicle 10. In this example, the power train 14 is a plug-in hybrid, and includes an electrically powered motor 16 and motor controller 18. The vehicle 10 may also include a gasoline powered engine 20 that supplements the electric motor 16 when required under certain operating conditions and a battery 22. The engine may operate on another fuel, such as, diesel, methane, propane, hydrogen, or the like. Various types of engines are contemplated, such as, a four-cylinder gasoline powered engine, or the like. The selection of engines is dependent on various factors including vehicle size, weight, battery capacity, or the like. The motor 16 can be an electric machine, such as, an electric motor. Example of a electric motors include 12 v high speed electric motor, DC series wound electric motor, permanent magnet DC electric motor, phase AC induction motor, or the like.

Referring to FIG. 3, a diagram of a motor drive system 12 for the vehicle 10 is shown. The motor drive system 12 includes various components coupled together in operative engagement, such as, a first motor 24, a second motor 26, a transmission or gearbox 28 (such as, a single-speed or multispeed transmission, or the like) having a gear (or a plurality of gears) or a differential 30, and a shaft (common rotatable shaft or drive shaft) 34 having a gear 36. The motor drive system also includes one or more, axles, shafts, or the like; operatively interconnecting the various components of the motor drive system 12.

The common shaft 34 includes a first end 36 operatively connected to the first motor 24 and a second end 38 operatively connected to the second motor 26. An example of a connection is a rotatable connection, or the like. The common shall 16 is also connected to the transmission 28 and may also include additional gears, such as, a pinion gear, planetary gear set, or the like. The transmission or gearbox 28 and differential 30 are positioned between the first motor 24 and the second motor 26. The shaft gear (pinion) 36 includes a plurality of teeth 40 and is located on the second end of the shaft 38. The shaft gear 36 can be concentrically mounted to and integrated with the shaft 34. The teeth of the shaft gear 40 are in meshed engagement with the transmission gear or differential 30. Under this configuration, there is a ninety degree input into the differential 30 wherein the first motor 24, the second motor 26, the transmission 28, differential 30, and common shaft 34 are mounted in-line with one another and laterally relative to the width of the vehicle 10.

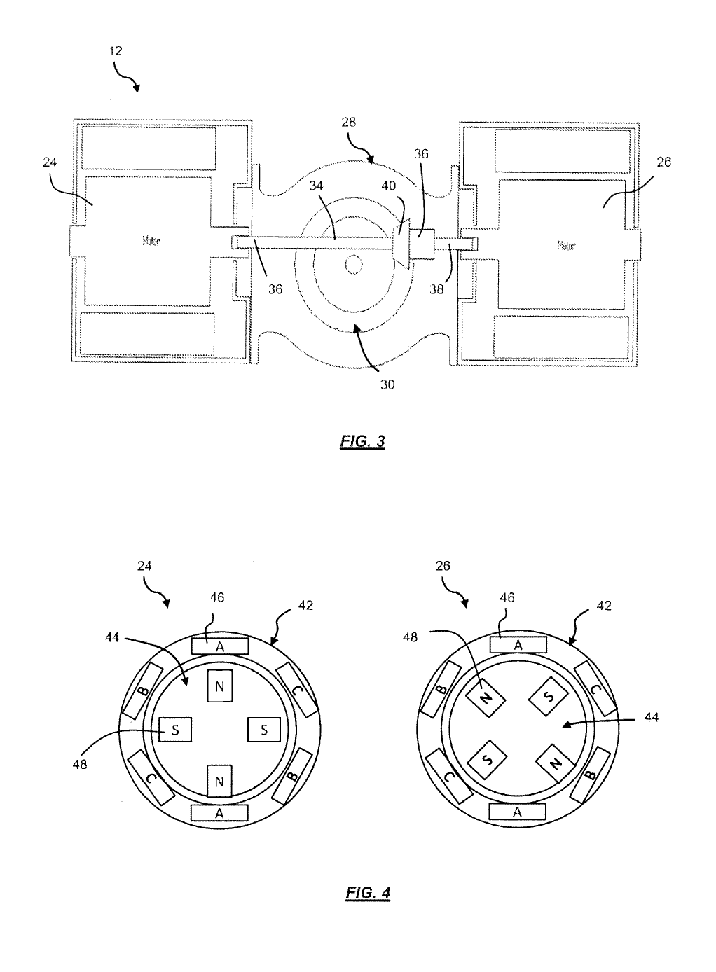

The first and second motor 24, 26 are mounted on the common shaft 34 such that the electrical phases of the first and second motors 24, 26 are offset from one another to thereby reduce the magnitude of torque ripple. To offset the first and second motors 24, 26, the motors 24, 26 are mounted out of phase from one another at a predetermined amount, such as, ninety electrical degrees, 180 electrical degrees, or the like. For example, the second motor 26 can be turned around the same axial path on which the two motors 24, 26 are mounted, as shown in FIG. 4. Although two motors 24, 26 are disclosed, a greater number of motors may he included in the motor drive system 12 and the motors may be offset from one another in a predetermined manner. The ideal amount of offset is dependent on the number of poles and the number of motors on the common shaft 34.

Referring now to FIG, 4, the alignment of the first and second motor 24, 26 in relative to one another during installation onto the common shaft 34 is shown, The first electric motor 24 and the second electric motors 26 include various components including a stator 42 and a rotor 44 that rotates about the stator 42. The stator 42 or the stationary component of the electric motors 24, 26 includes a plurality of wire coils (A, B, C) 46 arranged in a predetermined manner, such as, equidistant relative to one another around the circumference of the stator, or the like. The rotor 44 or the non-stationary component of the electric motors 24, 26 and includes a plurality of magnets 46 having their poles arranged in a predetermined manner, such as, alternating North (N) and South (S) poles and rotatably interacts with the stator 42. The rotor rotates because the wires and magnetic field of the motor are arranged so that a torque is developed about the rotor's axis. Offsetting the first motor 24 and the second motor 26, as shown and discussed above, mitigates the torque ripple effect created by the first motor 24 and the second motor 26.

The electrical phase refers to the electrical phase angle of the voltage wherein electrical degrees=poles/2*(mechanical degrees). For example, 12 poles is an acceptable value for a electric machine, such as, an electric motor. In other words, this means in order for the two motors 24, 26 to be 90 electrical degrees out of phase, one of the motors (e.g., the second motor 26) should be turned (offset) from the other motor (e.g., the first motor 24) a predetermined value, such as 15 degrees for a 12 pole machine, such as an electric motor.

This arrangement of the motor drive system 12 reduces torque ripple by having one motor (e.g.,, second motor 26) turned (offset) slightly so that when the other motor (e.g., first motor 24) has a peak in torque (high part of the ripple) the one motor has a torque trough (low part of the ripple), thereby minimizing the torque ripple effect. While ideally torque ripple is minimized in the motor design phase, this cannot always be accomplished. The arrangement of the motor drive system 12 of the present disclosure reduces the impact of a high torque ripple motor in situations where more than one motor is connected to a common shaft. Moreover, the arrangement of the motor drive system 12 of the present disclosure provides for greater versatility, options, and flexibility in terms of motor selection, and also reduces the cost to market of the vehicle, motor, or the like.

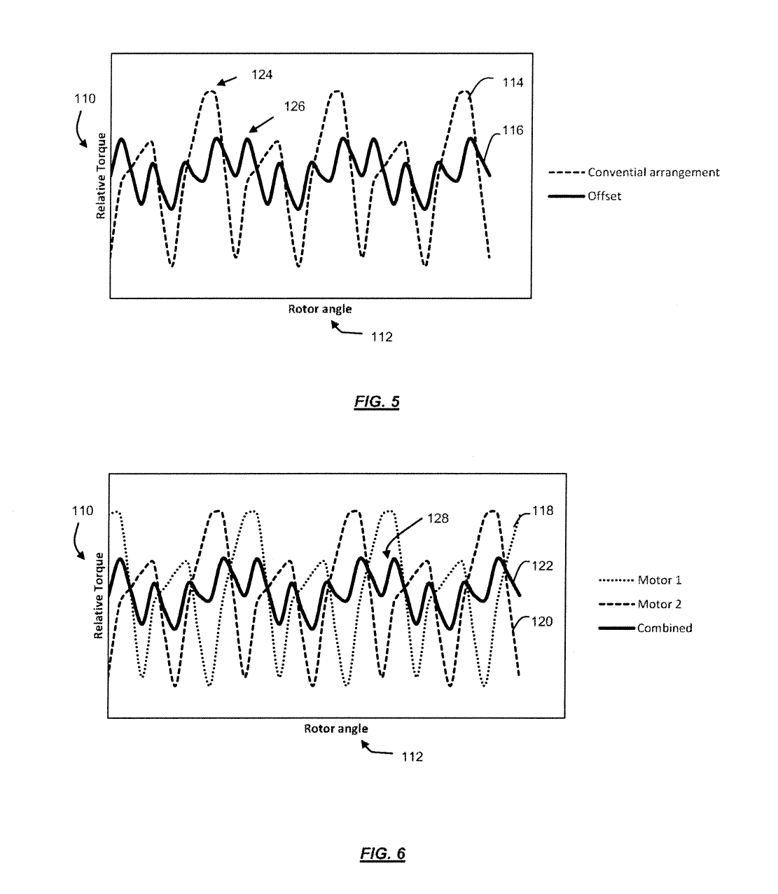

Referring now to FIGS. 5 and 6, a diagram comparing the torque ripple or the relative torque 110 (y-axis) versus the rotor angle 112 (x-axis) between a conventional motor arrangement 114 and the offset motor arrangement of the present disclosure 116, and a diagram comparing the relative torque versus 110 the rotor angle 112 between a first motor 118, a second motor 120, and combined first and second motor 122, is shown respectively. The torque ripple of a conventional drive unit (i.e., conventional arrangement) wherein the motors are operated such that their electrical phases are perfectly aligned (not offset) is relatively high, as shown in FIG. 5 at 124. In contrast, the torque ripple of the motor drive system 12 of the present disclosure (i.e., offset arrangement) wherein the motors 24, 26 are operated such that their electrical phases are offset from one another is relatively low, as shown in FIG. 5 at 126. As shown, a significant reduction in the torque ripple magnitude can he achieved by implementing the motor drive system 12 of the present disclosure.

With conventional drive units, the electrical phases are usually in the same location in relation to the mechanical position (i.e., electrical phases perfectly aligned). This means that two motors coming off the same assembly line are manufactured so that the poles are arranged exactly the same. This means that if the motors are fastened to a common shaft and mounted in the same manner, the torque ripple from each motor would coincide with the other. However, if one of the motors (e.g., second motor 26) is turned (for example, its mounting holes could be arranged in such a manner so that the motor 26 is turned 15 mechanical degrees (for a 12 pole machine)) this would cause the torque ripples to the 90 degrees out of phase so that the torque peak of the first motor 24 would correspond with the torque trough of the second motor 26 and vice versa (i.e., electrical phases offset), as disclosed in the present disclosure. Alternatively, the rotor 44 can be axially rotated so that after installation onto the common shaft 34, the rotor 44 will be phased desirably, as shown in FIG. 6 at 128.

It is noted that numerous variations may be contemplated by using the above described configuration/arrangement as its basis. This includes, but is not limited to motors mechanically linked using gears, chain drives, or any other method wherein the relative rotational position between two or more motors is dependent. This also includes motors that are periodically mechanically disconnected but can be controlled in such a manner that upon reengagement of the motors, the motors are phased (offset) for minimum torque ripple.

Many modifications and variations of the present disclosure are possible in light of the above teachings. Therefore, within the scope of the appended claim, the present disclosure may he practiced other than as specifically described.

What is claimed is:

1. A motor drive system for a vehicle, the motor drive system comprising:
a first electric motor operable for driving a first wheel of a vehicle;
a second electric motor operable for driving a second wheel of the vehicle; and
a rotatable shaft member having a first end and a second end, and the first electric motor is coupled to the first end of the rotatable shaft member and the second electric motor is coupled to the second end of the rotatable shaft member, wherein the first electric motor and the second electric motor are mounted a predetermined number of degrees out of phase from one another to minimize torque ripple.

2. The motor drive system of claim 1, wherein the first electric motor and the electric second motor are mounted 90 electrical degrees out of phase from one another to minimize torque ripple.

3. The motor drive system of claim 1, wherein the first electric motor and the electric second motor are mounted 180 electrical degrees out of phase from one another to minimize torque ripple.

4. The motor drive system of claim 1, wherein the first electric motor and the second electric motor are 12-pole machines.

5. The motor drive system of claim 4, wherein the second motor is mounted on the rotatable shaft such that the second motor is onset a predetermined number of mechanical degrees relative to the first motor mounted on the rotatable shaft.

6. The motor drive system of claim 3, wherein the second motor is mounted on the rotatable shaft such that the second motor is offset 15 mechanical degrees relative to the first motor mounted on the rotatable shaft.
